(19) United States
(12) Patent Application Publication
(10) Pub. No.: US 2025/0215897 A1
(43) Pub. Date: Jul. 3, 2025

(54) APPARATUS AND SYSTEM FOR INTEGRATED FLUID PUMPS

(71) Applicant: Cooper-Standard Automotive Inc., NORTHVILLE, MI (US)

(72) Inventors: David S. Malone, Attica, MI (US); Matthew J. Klenk, COMMERCE TOWNSHIP, MI (US)

(73) Assignee: Cooper-Standard Automotive Inc., NORTHVILLE, MI (US)

(21) Appl. No.: 18/400,112

(22) Filed: Dec. 29, 2023

(51) Int. Cl. F04D 29/62; F04D 25/06

(52) U.S. Cl. CPC F04D 29/62; F04D 25/06

(57) ABSTRACT

An apparatus and system for coupling electrical signals between a valve section and a motherboard located in a pump section of an integrated valve and fluid pump device. The apparatus and system includes a lead-frame located in the valve section having a plurality of lead-frame electrical conductors connected to at least one electrical component located in the valve section. A bridge-frame having a plurality of bridge-frame electrical conductors is connected to the motherboard on a first terminal end and to the lead-frame electrical conductors on a second terminal end. The bridge-frame couples the electrical signals between the motherboard and the lead-frame and the electrical component in the valve section.

### TECHNICAL FIELD

This disclosure is directed to an apparatus and system for electrically connecting electrical components controlling a valve to a motherboard controlling a pump motor of an integrated fluid pump.

### BACKGROUND

Electrically operated fluid pumps are known and commonly used to move fluids in thermal management systems, such as coolant in a vehicle. One example of a thermal management system is the cooling of battery systems of a hybrid or purely electric vehicle. The fluid pumps are operated at various speeds to increase or decrease the flow of coolant through the thermal management system based on demand from a vehicles central computer. Valves may be used in conjunction with the fluid pump to regulate flow from the pump to ensure the distribution of the coolant throughout the thermal management system. The valves may also be used to switch fluid into the pump from various devices that the pump serves. The valves each require use of an electrical actuator motor that drives the valve to switch the flow of coolant from the valve or into the valve.

Currently known fluid pumps can include a valve integrated with the fluid pump, where the electrical motor that moves the valve is located within the same housing as the electrical motor that drives the pump. Both devices are packaged as a single integrated unit. Power and control signals for operating the fluid pump electrical motor and the valve actuator electrical motor are provided from motor drivers located at the vehicle's central computer. The motor drivers are commanded by the vehicle central computer to energize the electrical pump motor at various pump speeds and/or to activate the actuator motor to position the valve in several switched positions. Additionally, the actuator electrical motor may include a position sensor that provides feedback signals back to the motor drivers that report the valve's current switched position. Power and control connections between such an integrated pump and valve and the remotely located motor drivers use separate wiring bundles that each separately connect the fluid pump and the valve resulting in wiring complexity and high component costs.

### SUMMARY

This disclosure is directed to an apparatus and system for electrically connecting electrical components controlling a valve to a motherboard controlling a pump motor of an integrated fluid pump.

In a first embodiment an apparatus is disclosed for coupling electrical signals between a valve section and a motherboard located in a pump section of an integrated valve and fluid pump device. The apparatus comprises a lead-frame located in the valve section having a plurality of lead-frame electrical conductors connected to at least one electrical component located in the valve section. A bridge-frame having a plurality of bridge-frame electrical conductors has the bridge-frame electrical conductors connected to the motherboard on a first terminal end and to the lead-frame electrical conductors on a second terminal end. The bridge-frame couples the electrical signals between the motherboard and the lead-frame and the at least one electrical component.

In a second embodiment a system is disclosed for coupling electrical signals between at least one electrical component located in a valve section, and a motherboard located in a pump section of an integrated valve and fluid pump device. The system comprises a lead-frame located in the valve section containing a plurality of lead-frame electrical conductors with a set of the plurality of lead-frame electrical conductors connected to the at least one electrical component. A bridge-frame located externally of the integrated valve and fluid pump device includes a plurality of bridge-frame electrical conductors having a first terminal end connected to the motherboard and a second terminal end connected to the plurality of lead-frame electrical conductors. The plurality of bridge-frame electrical conductors couple the electrical signals between the first terminal end and the motherboard to the second terminal end and the plurality of lead-frame electrical conductors.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is an isometric view of an integrated device incorporating the apparatus and system of the present disclosure;

FIG. 2 is an isometric view of FIG. 1 exposing the internal arrangement of the integrated device:

FIG. 3 an isometric view of the terminal connections between the bridge-frame and motherboard in accordance with the present disclosure;

FIG. 4 is an isometric view of the lead-frame and its interconnections to the bridge-frame and to an actuator motor and sensor board in accordance with the present disclosure:

FIG. 5 is another isometric view of the lead-frame in accordance with the present disclosure:

FIG. 6 is an isometric view of the electrical connections between the electrical conductors of the lead-frame and terminals of the bridge-frame:

FIG. 7 is an isometric view of the bridge-frame in accordance with the present disclosure:

FIG. 8 is a section plan view of the bridge-frame from an opposite side of the view of FIG. 7:

FIG. 9 is an isometric section view illustrating the connection of a first terminal end of the bridge-frame to the integrated device in accordance with the present disclosure; and

FIG. 10 is an isometric section view illustrating the connection of a second terminal end of the bridge frame to the integrated device in accordance with the present disclosure.

### DETAILED DESCRIPTION

The figures discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

The present disclosure comprises an actuator lead-frame and a bridge-frame containing electrical conductors that electrically connect an integrated device comprised of a fluid pump driven by a pump motor and a valve pensionable by an actuator motor. The fluid pump is located in a pump section of the integrated device and the valve in a valve section of the integrated device. The pump section houses the pump motor that when energized causes fluid to be pumped by the pump. The valve actuator motor is housed within the valve section, that when energized, causes a valve to control the flow of fluid from one or more fluid inlets to one or more fluid outlets. For example, the actuator motor, when energized may selectively place the valve in one or more selected switched positions that fluidically connect a fluid inlet to one or more fluid outlets. A valve position sensor located in the valve section provides a feedback signal representing the current position of the valve. The actuator lead-frame includes electrical conductors that connect the actuator motor and the valve position sensor.

The bridge-frame includes a set of electrical conductors housed in the bridge-frame that include a first set of electrical terminals on a first end of the bridge-frame. The first set of electrical terminals electrically connect to a motherboard located in the base of the pump section. The motherboard contains motor drivers for the pump motor and the actuator motor that provide power and control signals to the pump motor and the actuator motor. The pump motor is directly connected to the motherboard and to an associated motor driver. The motherboard further includes a control circuit that receives the feedback signals from the valve position sensor through associated electrical conductors located in the bridge-frame. An electrical connector connects the motherboard to a central computer that sends commands to control the operation of the motor drivers and the control circuit.

The electrical conductors housed in the bridge-frame terminate at a second end to a second set of electrical terminals that electrically connect the bridge-frame conductors to the actuator lead-frame, which deliver power from an associated motor driver on the motherboard to the actuator motor and the feedback signals from the valve position sensor to the control circuit.

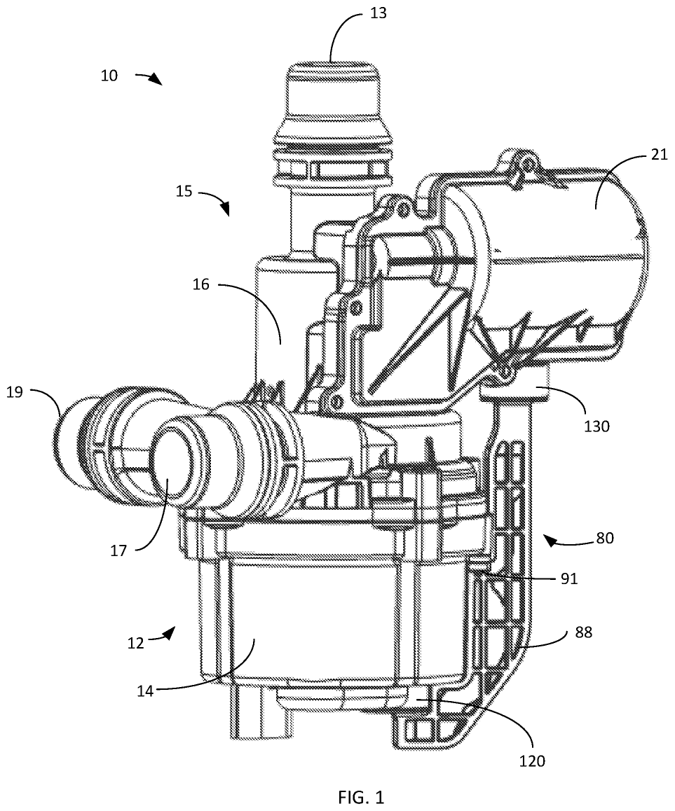

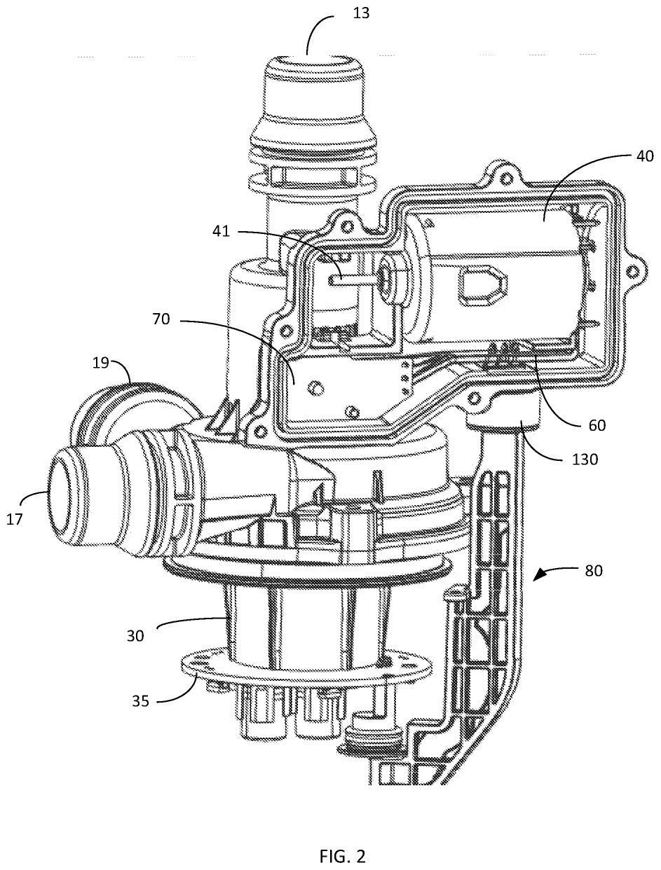

FIGS. 1-3 illustrate an integrated device 10 that uses the actuator lead-frame and bridge-frame of the present disclosure. The device 10 comprises a pump section 12 containing a motor driven pump 30 and a motherboard 35 housed inside a pump section cover 14. A valve section 15 contains a positionable valve contained within a valve section cover 16. An inlet port 13 and a first and a second outlet port 17 and 19 respectively, extend from the valve section cover 16.

The bridge-frame 80 contains electrical conductors housed internally in the bridge-frame. In the current disclosure, five conductors are housed in the bridge-frame. A first set of two conductors provide power to actuator motor 40 and a second set of three conductors return feedback signals from the valve sensor board 70 to motherboard 35. It will be understood by those skilled in the art that other combinations of conductors can be used in other embodiments in accordance with the teachings of the present disclosure.

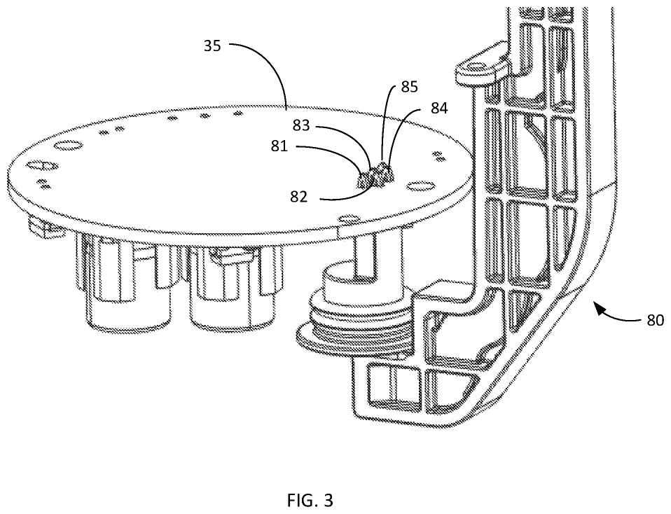

The bridge-frame 80 is located on the exterior of the integrated device 10 from the pump section cover 14 of the pump section 12 to the valve section cover 16 of valve section 15. A fastener 91 attaches the bridge-frame 80 to the motor section housing cover 14. Electrical terminals 81, 82, 83, 84 and 85 extend from a first terminal end of the bridge-frame 80 with each electrical terminal, of electrical terminals 81-85 connect to a one of the first and second sets of electrical conductors. For example, terminals 81 and 82 connect to the first set of two conductors, and terminals 83, 84 and 85 to the second set of three conductors. Each terminal 81-85 is electrically connected to the motherboard 35 as shown in FIG. 3. A second set of terminals extend from a second terminal end of the bridge-frame 80 and are arranged to be electrically connected to an actuator lead-frame 60. Each terminal 81-85 on the first terminal end of the bridge-frame 80 is electrically connected to an associated terminal 81′-85′ on the second terminal end of the bridge-frame by an associated conductor.

An actuator motor 40 has a motor shaft 41 connected through a gear system (not shown) to the valve. The actuator motor 40, when energized rotates the motor shaft 41, causing the valve to be selectively positioned and cause the connection of the inlet port 13 to one or the other outlet ports 17 or 19. The actuator motor 40 is located in the valve section 15 behind an actuator cover 21. A sensor board 70 is located in the valve section 15 behind the actuator cover 21. The sensor board 70 includes the valve position sensor that records and transmits the valve's position and sends feedback signals representing the valve's position to the control circuit on the motherboard 35.

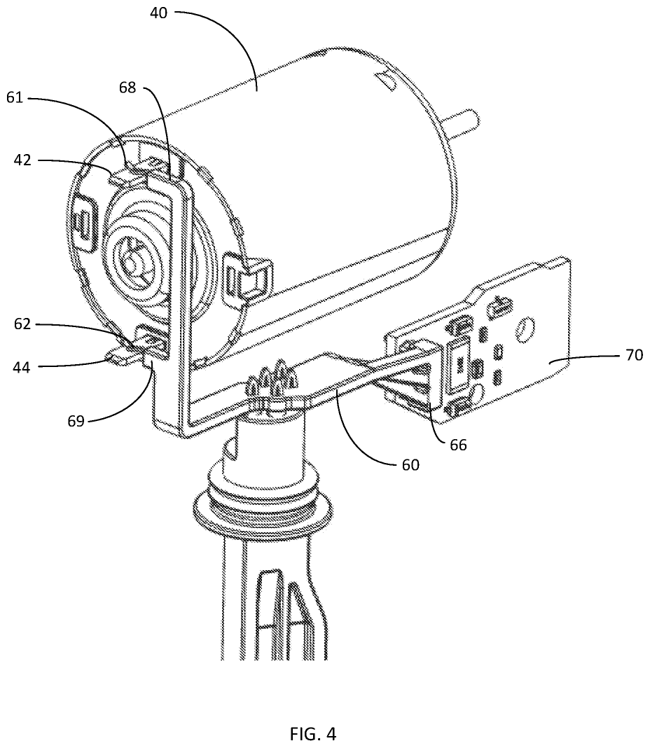

With reference to FIGS. 4-6 the actuator lead-frame 60 is constructed by placing a set of stamped copper alloy conductors in a carrier structure and over-molding a thermoplastic material over the carrier structure and the conductors. The carrier structure retains the conductors in a space relationship from the other during the over-molding process. The material applied during the over-molding process flows over and between the electrical conductors in the lead-frame 60 isolating each conductor from the other in the lead-frame. A first set of conductors comprising conductors 61 and 62 extend from a pair of arms 68 and 69 of the lead-frame 60 to electrically connect to actuator terminals 42 and 44. Actuator terminals 42 and 44 are located on a back portion of the actuator motor 40. A second set of conductors 63, 64 and 65 extend from a connector portion 66 of the lead-frame 60 and connect to the sensor board 70 using any suitable method for making a fixed electrical connection.

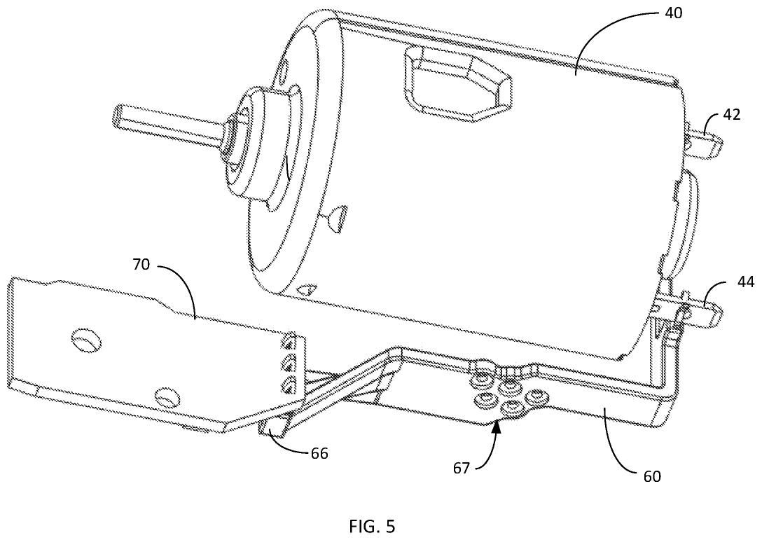

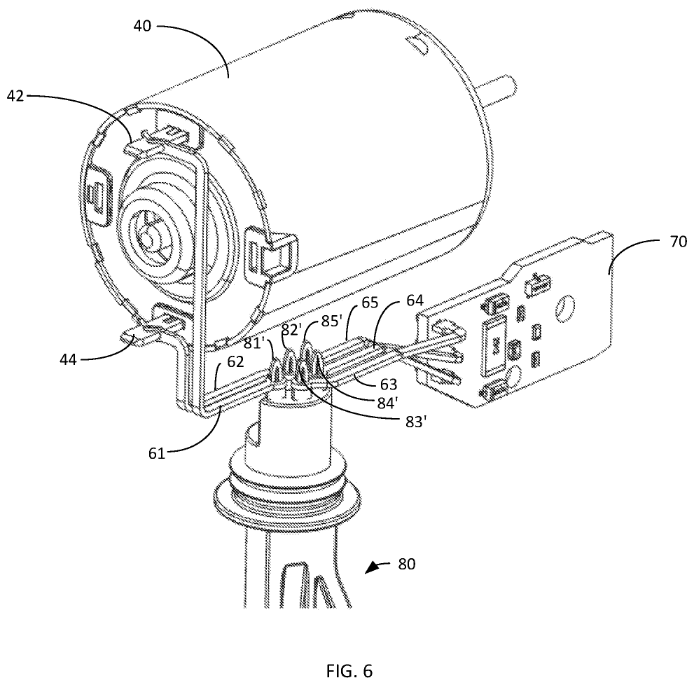

FIG. 6 illustrates the conductors 61, 62, 63, 64 and 65 of the lead-frame 60 with the lead-frame removed. As shown in FIG. 6, each terminal 81′-85′ from the second end of the bridge frame 80 enters a respective plated opening 67 formed in the lead-frame 60 mechanically and electrically connecting a respective conductor 61-65 to a respective terminal 81′-85′. As is best seen in FIG. 5, openings 67 are centrally located on the actuator lead-frame 65. Terminals 81′ and 82′ from the second terminal end of bridge-frame 80 are received through a respective opening 67 and make a mechanical connection into an opening 67 to electrically connect conductors 61 and 62 and actuator terminals 42 and 44 to the motherboard 35. Terminals 83′, 84′ and 85′ mechanically connect to a respective opening 67 to electrically connect the sensor board 70 and conductors 63-65 to the motherboard 35.

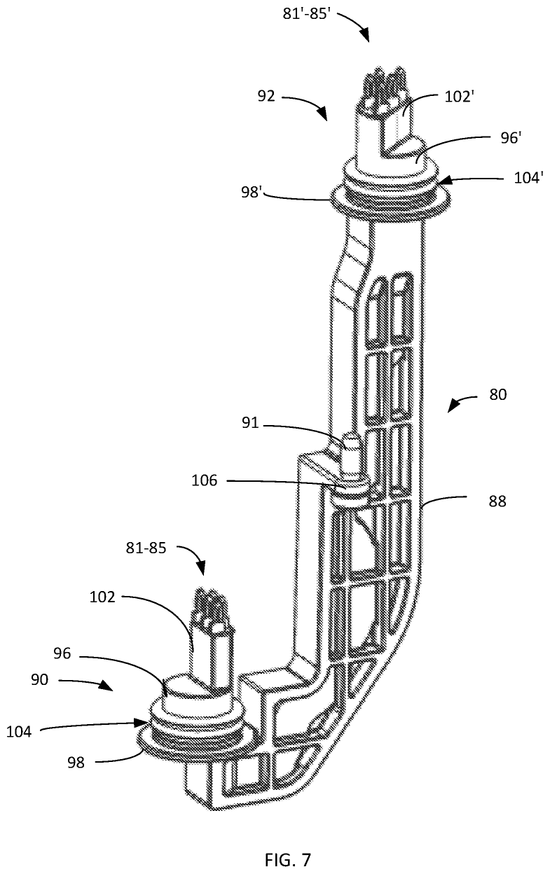

FIGS. 7-10 illustrate the bridge-frame 80 of the present disclosure. The bridge-frame 80 is composed of a body 88 extending between the first terminal end 90 and the second terminal end 92. The body 88 is constructed by placing a set of stamped copper alloy conductors 94 in a carrier structure and over-molding the carrier structure and the conductors with a thermoplastic material. The carrier structure retains the conductors in place during the over-molding process. The material applied during the over-molding process flows over the carrier structure and between the electrical conductors 94 isolating each conductor from the other in body 88.

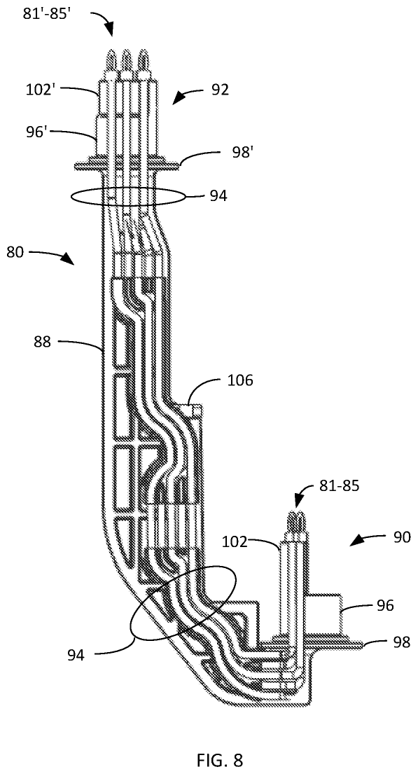

An end of each of the conductors 94 extends from an end of the bridge-frame 80 as a terminal. Terminals 81, 82, 83, 84 and 85 (hereinafter referred as terminals 81-85) extend from the first terminal end 90 and terminals 81′, 82′, 83′, 84′ and 85′ (hereinafter referred as terminals 81′-85′) extend from the second terminal end 92. As shown in FIG. 8, each terminal of terminals 81-85 are coupled to a respective terminal 81′-85′ by a respective conductor 94 within body 88 of the bridge-frame 80. In the present embodiment, five conductors are located within body 88 corresponding to the first and second set of conductors explained above.

The first terminal end 90 includes a barrel 96 extending from an annular flange 98. A semi-circular key member 102 extends from a top surface of barrel 96. Terminals 81-85 extend outward from a top surface of the key member 102. Two O-ring sealing members 104 are located around an exterior surface of the barrel 96.

The second terminal end 92 is constructed similarly to the first terminal 90 and also includes a barrel 96′ extending from an annular flange 98′. A semi-circular key member 102′ extends from a top surface of barrel 96′. Terminals 81′-85′ also extend outward from a top surface of the key member 102′. Two O-ring sealing members 104 are located around the exterior surface of the barrel 96′. A threaded fastener 91 is placed within a fastener receiver 106 molded to body 88.

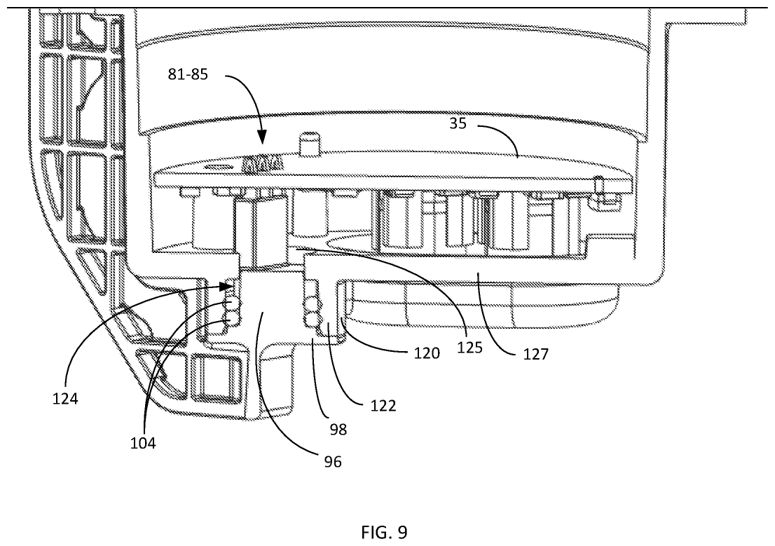

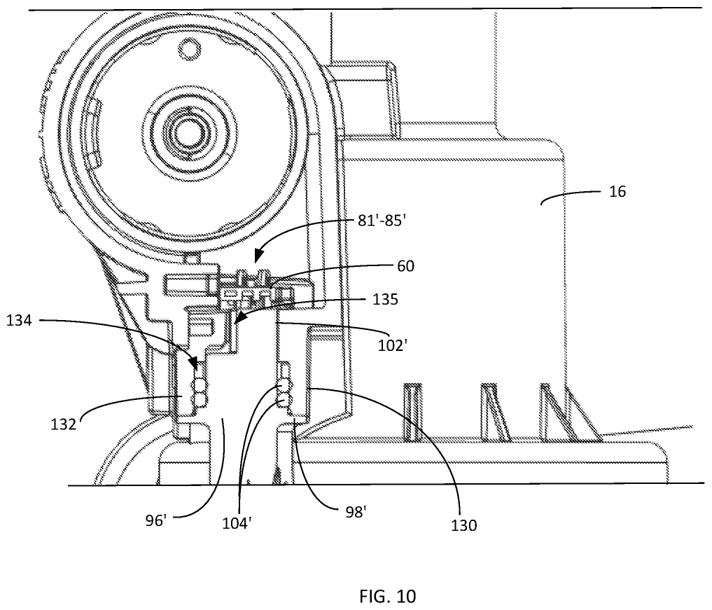

FIGS. 9 and 10 illustrate in sectional perspective views the termination of the first and second terminal ends 90 and 92 of the bridge-frame 80 to the motherboard 35 and the lead-frame 60. Terminal end 90 of bridge-frame 80 plugs into a socket 120 formed in the pump section cover 14 and terminal end 92 plugs into a socket 130 extending from the valve section cover 16 adjacent actuator cover 21. Both terminal ends 90 and 92 are each plugged into their respective sockets 120, 130 simultaneously when installing the bridge-frame 80 to the integrated device 10.

With reference to FIG. 9, the connection of the first terminal end 90 of the bridge-frame 80 to socket 120 is illustrated. The socket 120 includes an annular wall 122 defining a cavity 124 therebetween. The socket annular wall 122 is sized to accept the barrel 96 of the first terminal end 90 within the cavity 124. O-ring seals 104 contact an inner surface of socket wall 122 to form a seal between the barrel 96 and the wall 122. A circular opening 125 in a bottom floor 127 of the cover accepts an arcuate portion of the key member 96 against a peripheral portion of the of the opening 125 that guides terminals 81-85 to be accepted within plated holes (not shown) on motherboard 35. The first terminal end 90 is inserted into the cavity 124 until flange 98 rests on a top surface of socket wall 122. With the barrel 96 of terminal end 90 fully inserted into cavity 124 each terminal 81-85 is mechanically accepted with a respective plated hole on motherboard 35 making an electrical connection to the motherboard 35 and the motor driver that drives the actuator motor 40 and the control circuit that receives the feedback signals from the sensor board 40.

With reference to FIG. 10, the connection of the second terminal end 92 of the bridge frame 80 to the socket 130 is illustrated. The socket 130 includes an annular wall 132 defining a cavity 134 therebetween. The socket annular wall 132 is sized to accept the barrel 96′ of the second terminal end 92 within the cavity 134. O-ring seals 104′ contact an inner surface of socket wall 134 to form a seal between the barrel 96′ and the wall socket wall 132. An upper end of the cavity 134 includes a semi-circular portion 135 sized to allow the semi-circular key portion 102′ to enter into portion 135 and guide terminals 81′-85′ into respective plated holes 67 of the lead-frame 60 as shown and explained in FIG. 4. The second terminal end 92 is inserted into the cavity until flange 98′ rests on a top surface of socket wall 132. The bridge-frame 80 is secured to the integrated device 10 by inserting a threaded fastener 91 within a fastener receiver 106 molded to body 88 and threading the fastener to a threaded hole on the motor section cover 14.

It may be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” or “controller” within a claim is understood and intended to refer to structures known to those skilled in the relevant art, as further modified or enhanced by the features of the claims themselves and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus for coupling electrical signals between a valve section and a motherboard located in a pump section of an integrated valve and fluid pump device, the apparatus comprising:
a lead-frame located in the valve section having a plurality of lead-frame electrical conductors connected to at least one electrical component located in the valve section; and
a bridge-frame having a plurality of bridge-frame electrical conductors, the bridge-frame electrical conductors connected to the motherboard on a first terminal end and to the lead-frame electrical conductors on a second terminal end,
wherein the bridge-frame couples the electrical signals between the motherboard and the lead-frame and the at least one electrical component.

2. The apparatus of claim 1, wherein the bridge-frame includes a body portion located between the first and the second terminal ends.

3. The apparatus of claim 2, wherein the plurality of bridge-frame electrical conductors are located internal to the body portion.

4. The apparatus of claim 1, wherein the plurality of bridge-frame electrical conductors include a plurality of first terminals extending from the first terminal end and a plurality of second electrical terminals extending from the second terminal end.

5. The apparatus of claim 4, wherein the pump section includes a socket arranged to accept the first terminal end within the socket and guide the plurality of first terminals to engage and make an electrical connection to the motherboard.

6. The apparatus of claim 3, wherein the body portion and the first and second terminal ends are molded as a unitary structure that is attached externally to the integrated valve and fluid pump device.

7. The apparatus of claim 4, wherein the lead-frame is composed as a unitary structure having the plurality of lead-frame electrical conductors located within the lead-frame.

8. The apparatus of claim 7, wherein the plurality of lead-frame conductors include a plurality of electrical terminals extending from opposing ends of the lead-frame, a selected set of the lead-frame electrical terminals electrically connected to the at least one electrical component.

9. The apparatus of claim 7, wherein the lead-frame includes a plurality of plated holes located on the lead-frame, each plated hole connected to a respective one of the plurality of lead-frame electrical conductors.

10. The apparatus of claim 9, wherein the valve section includes a socket arranged to accept the second terminal end of the bridge-frame within the socket and guide the plurality of second terminals from the bridge-frame to engage and make an electrical connection to the plurality of plated holes.

11. A system for coupling electrical signals between at least one electrical component located in a valve section, and a motherboard located in a pump section of an integrated valve and fluid pump device, the system comprising:
a lead-frame located in the valve section containing a plurality of lead-frame electrical conductors, a set of the plurality of lead-frame electrical conductors connected to the at least one electrical component:
a bridge-frame located externally of the integrated valve and fluid pump device having a plurality of bridge-frame electrical conductors and a first terminal end connected to the motherboard and a second terminal end connected to the plurality of lead-frame electrical conductors,
wherein the plurality of bridge-frame electrical conductors couple the electrical signals between the first terminal end and the motherboard to the second terminal end and the plurality of lead-frame electrical conductors.

12. The system of claim 11, wherein the bridge-frame includes a body portion located between the first and the second terminal ends.

13. The system of claim 12, wherein the body portion and the first and second terminal ends are molded as a unitary structure and the plurality of bridge-frame electrical conductors are molded internally within the body portion.

14. The system of claim 13, wherein the plurality of bridge-frame electrical conductors include a plurality of first terminals extending from the first terminal end and a plurality of second electrical terminals extending from the second terminal end.

15. The system of claim 14, wherein the pump section includes a socket arranged to accept the first terminal end within the socket and guide the plurality of first terminals to engage and make an electrical connection to the motherboard.

16. The system of claim 15, wherein the body portion is externally attached to the integrated valve and fluid pump device.

17. The system of claim 14, wherein the lead-frame is composed as a molded unitary structure having the plurality of lead-frame electrical conductors located and molded within the lead-frame structure causing each lead-frame electrical conductor to be electrically isolated from the other.

18. The system of claim 17, wherein the plurality of lead-frame electrical conductors include a plurality of electrical terminals extending from opposing ends of the lead-frame, wherein a selected set of the plurality of electrical terminals are connected to the at least one electrical component in the valve section.

19. The system of claim 18, wherein the lead-frame includes a plurality of plated holes located on the lead-frame, each plated hole connected to a respective one of the plurality of lead-frame electrical conductors.

20. The system of claim 19, wherein the valve section includes a socket arranged to accept the second terminal end of the bridge-frame within the socket and guide the plurality of second terminals from the bridge-frame to engage and make connections to the plurality of plated holes that couple the electrical signals between the bridge-frame first terminal end and the motherboard to the bridge frame second terminal end and the lead-frame electrical terminals.
